(19) United States
(12) Patent Application Publication
(10) Pub. No.: US 2026/0278757 A1
(43) Pub. Date: Sep. 17, 2026

(54) IMAGE ENHANCEMENT OF LOW-LIGHT OR OTHER IMAGES WITH ADAPTIVE AFFINE COLOR CORRECTION MODEL

(71) Applicant: Samsung Electronics Co., Ltd., Suwon-si (KR)

(72) Inventor: Yingen Xiong, Mountain View, CA (US)

(21) Appl. No.: 19/530,059

(22) Filed: Feb. 4, 2026

Related U.S. Application Data
(60) Provisional application No. 63/770,199, filed on Mar. 11, 2025.

(51) Int. Cl. G06T 5/92; G06T 5/40; G06T 5/70; G06T 7/00; G06T 7/80; G06T 11/10

(52) U.S. Cl. CPC G06T 5/92; G06T 5/40; G06T 5/70; G06T 7/0002; G06T 7/80; G06T 11/10; G06T 2207/10024; G06T 2207/20008; G06T 2207/30168

(57) ABSTRACT

A method includes obtaining, using at least one processing device of an electronic device, an input image frame captured using an imaging sensor. The method also includes determining, using the at least one processing device, parameters of an adaptive affine color correction model based on the input image frame. The method further includes performing, using the at least one processing device, image visual quality enhancement using the adaptive affine color correction model to generate an enhanced image frame based on the input image frame. In addition, the method includes initiating, using the at least one processing device, display of a rendered image based on the enhanced image frame.

### CROSS-REFERENCE TO RELATED APPLICATION AND PRIORITY CLAIM

This application claims priority under 35 U.S.C. § 119 (e) to U.S. Provisional Patent Application No. 63/770,199 filed on Mar. 11, 2025. This provisional patent application is hereby incorporated by reference in its entirety.

### TECHNICAL FIELD

This disclosure relates generally to image processing systems and processes. More specifically, this disclosure relates to image enhancement of low-light or other images with an adaptive affine color correction model.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to image enhancement of low-light or other images with an adaptive affine color correction model.

In a first embodiment, a method includes obtaining, using at least one processing device of an electronic device, an input image frame captured using an imaging sensor. The method also includes determining, using the at least one processing device, parameters of an adaptive affine color correction model based on the input image frame. The method further includes performing, using the at least one processing device, image visual quality enhancement using the adaptive affine color correction model to generate an enhanced image frame based on the input image frame. In addition, the method includes initiating, using the at least one processing device, display of a rendered image based on the enhanced image frame.

In a second embodiment, an apparatus includes at least one processing device configured to obtain an input image frame captured using an imaging sensor and determine parameters of an adaptive affine color correction model based on the input image frame. The at least one processing device is also configured to perform image visual quality enhancement using the adaptive affine color correction model to generate an enhanced image frame based on the input image frame. The at least one processing device is further configured to initiate display of a rendered image based on the enhanced image frame.

In a third embodiment, a non-transitory machine readable medium contains instructions that when executed cause at least one processor of an electronic device to obtain an input image frame captured using an imaging sensor and determine parameters of an adaptive affine color correction model based on the input image frame. The non-transitory machine readable medium also contains instructions that when executed cause the at least one processor to perform image visual quality enhancement using the adaptive affine color correction model to generate an enhanced image frame based on the input image frame. The non-transitory machine readable medium further contains instructions that when executed cause the at least one processor to initiate display of a rendered image based on the enhanced image frame.

Any one or any combination of the following features may be used with the first, second, or third embodiment.

One or more light conditions of the input image frame may be identified, and a determination may be made whether the one or more light conditions of the input image frame are acceptable. The image visual quality enhancement may be performed in response to determining that the one or more light conditions of the input image frame are not acceptable.

The one or more light conditions may include a brightness and a contrast of the input image frame. The parameters of the adaptive affine color correction model may include a bias for brightness control and a gain for contrast control.

After performing the image visual quality enhancement, image visual quality verification of a resulting image frame may be performed. Determination of the parameters of the adaptive affine color correction model and performance of the image visual quality enhancement may be repeated using the resulting image frame in response to the image visual quality verification.

The parameters of the adaptive affine color correction model may be determined by generating a histogram using the input image frame; determining a cumulative distribution of the input image frame using the histogram; determining a pixel value range for enhancement using the cumulative distribution; and determining the parameters of the adaptive affine color correction model using the pixel value range.

Prior to determining the parameters of the adaptive affine color correction model, the input image frame may be converted from a first color space into a second color space having a luminance channel. After performing the image visual quality enhancement, the enhanced image frame may be converted from the second color space to the first color space or to a third color space. The parameters of the adaptive affine color correction model may be determined based on the luminance channel.

The parameters of the adaptive affine color correction model may be based on calibration data from calibration of the imaging sensor. The calibration data may be updated over time.

Noise reduction may be performed to generate the enhanced image frame.

A passthrough transformation may be applied to the input image frame or the enhanced image frame. The passthrough transformation may include a static transformation and a dynamic transformation that collectively transform image data from a viewpoint of the imaging sensor to a viewpoint of a user's eye.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for image enhancement of low-light or other images with an adaptive affine color correction model in accordance with this disclosure;

FIG. 3 illustrates a more specific example process for image enhancement of low-light or other images with an adaptive affine color correction model in accordance with this disclosure;

FIG. 4 illustrates an example process for adaptive affine color correction model generation in accordance with this disclosure;

FIG. 5 illustrates an example process for image brightness and contrast enhancement of low-light or other images with an adaptive affine color correction model in accordance with this disclosure; and

FIG. 6 illustrates an example method for image enhancement of low-light or other images with an adaptive affine color correction model in accordance with this disclosure.

### DETAILED DESCRIPTION

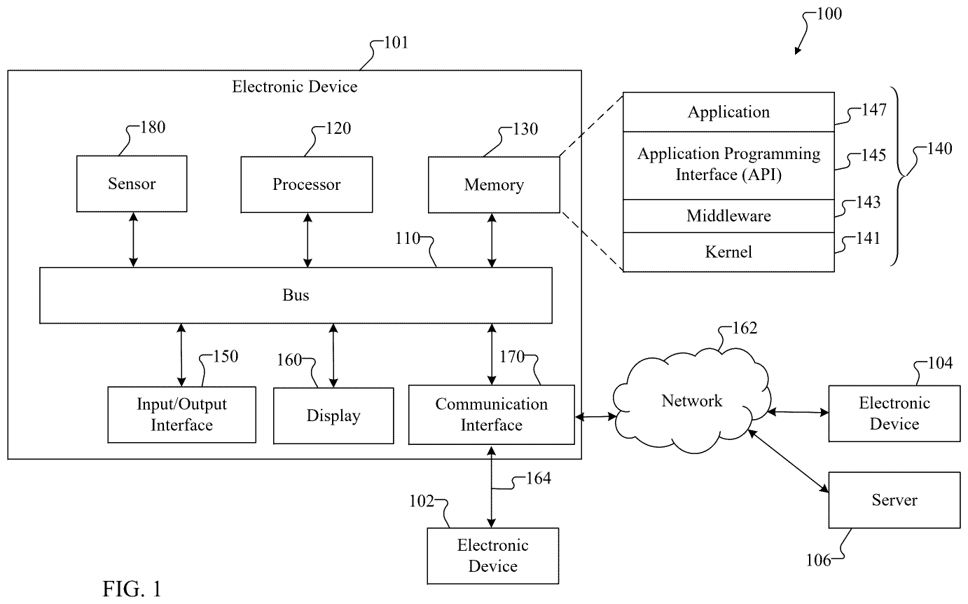

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Unfortunately, VST XR devices can suffer from various problems. Among other things, the quality of the image frames captured by the imaging sensors can be very important for a user to access his or her physical surroundings. One factor that affects image visual quality is environment lighting. VST XR devices are often used in a variety of lighting environments, including well-lit environments and dark or other low-light environments. When the environment lighting is inadequate (such as in dark or other low-light environments), dark and noisy image frames can be obtained. When rendered for a user, the resulting rendered images can suffer from poor lighting, blur, and noise.

This disclosure provides various techniques supporting image enhancement of low-light or other images with an adaptive affine color correction model. As described in more detail below, an input image frame captured using an imaging sensor can be obtained, and parameters of an adaptive affine color correction model can be determined based on the input image frame. Image visual quality enhancement can be performed using the adaptive affine color correction model to generate an enhanced image frame based on the input image frame. A rendered image based on the enhanced image frame can be displayed. This can be repeated any number of times to process any number of input image frames and present any number of rendered images.

In this way, the disclosed techniques provide an efficient mechanism to improve the visual quality of image frames captured in low-light or other environments by see-through cameras or other imaging sensors of a VST XR device or other device. In some cases, the quality-improved image frames can be used to generate high-quality final views of a surrounding scene by a VST XR pipeline or other image processing pipeline. Moreover, the disclosed techniques can adaptively improve image visual quality, such as by enhancing image brightness and contrast as needed. One overall result here is that improved rendered images can be provided to a user, which may enable the user to perceive his or her physical environment better. In some cases, from the user's perspective, the user may not be able to discern whether the rendered images displayed to the user are from a wet-lit or low-light environment.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to image enhancement of low-light or other images with an adaptive affine color correction model.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform image enhancement of low-light or other images with an adaptive affine color correction model. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit (IMU) that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to image enhancement of low-light or other images with an adaptive affine color correction model.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

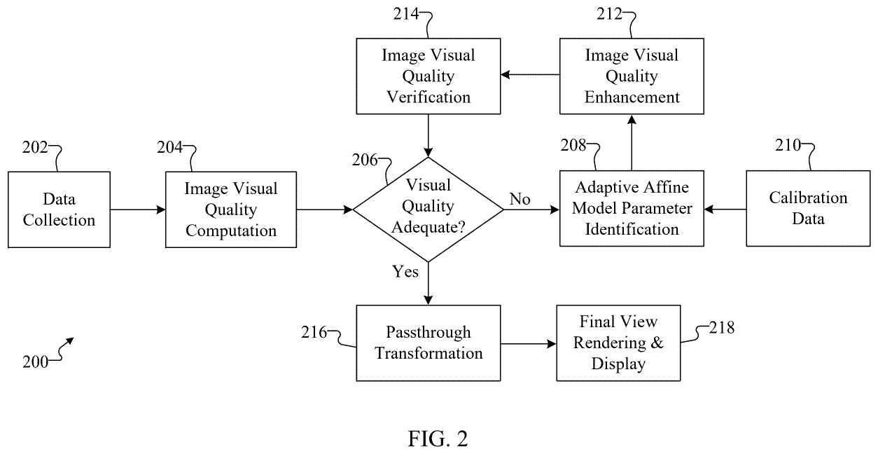

FIG. 2 illustrates an example process 200 for image enhancement of low-light or other images with an adaptive affine color correction model in accordance with this disclosure. For ease of explanation, the process 200 shown in FIG. 2 is described as being implemented using the electronic device 101 in the network configuration 100 shown in FIG. 1. However, the process 200 shown in FIG. 2 may be implemented using any other suitable device(s) and in any other suitable system(s).

As shown in FIG. 2, the process 200 includes a data collection operation 202, which generally operates to obtain input image frames and optionally other information to be processed. In some cases, for example, the information could be obtained using various sensors 180 of the electronic device 101. As a particular example, the data collection operation 202 could be used to obtain high-resolution color image frames from see-through color imaging sensors 180. In some embodiments, the data collection operation 202 may be used to obtain input image frames at a desired frame rate, such as 30, 60, 90, or 120 frames per second. The data collection operation 202 may also be used to obtain input image frames from any suitable number of imaging sensors 180, such as from left and right see-through cameras. Each input image frame can have any suitable size, shape, and resolution and include image data in any suitable domain. As particular examples, each input image frame may include RGB image data, YUV image data, or Bayer or other raw image data.

In some cases, the data collection operation 202 may obtain input image frames along with depth data from one or more depth sensors 180, head poses from one or more positional sensors 180, and/or eye tracking data from one or more eye tracking sensors 180. The depth data may generally represent measurements or estimates of the depths within a scene, meaning distances between the electronic device 101 and various points within the scene. The depth data may be obtained using any suitable sensor(s) 180, such as one or more time-of-flight (ToF) sensors, light detection and ranging (LiDAR) sensors, or stereo vision sensors. The head pose data may represent measurements or estimates of the pose of a user's head while the electronic device 101 is being used. In some cases, the head pose data may be expressed using six degrees of freedom, such as three translation values identifying movement of the user's head along three orthogonal axes and three rotation values identifying rotation of the user's head about the three orthogonal axes. The head pose data may be obtained using any suitable sensor(s) 180, such as from one or more IMUs. The eye tracking data may represent measurements or estimates of (or related to) the direction in which the user of the electronic device 101 appears to be looking. In some cases, the eye tracking data may be expressed as a gaze direction, a focal distance, or a combination thereof. The eye tracking data may be obtained using any suitable sensor(s) 180, such as from one or more high-resolution cameras that capture image frames of the user's eyes during illumination by one or more infrared or other illuminators (like one or more light emitting diodes in the electronic device 101).

For each input image frame, an image quality computation operation 204 generally operates to estimate the visual quality of the input image frame. The image quality computation operation 204 may generate any suitable visual quality measurement(s) associated with the input image frame. In some embodiments, the image quality computation operation 204 could generate one or more metrics associated with one or more light conditions of the input image frame. The one or more light conditions may, for example, include a brightness of the input image frame and/or a contrast of the input image frame. In some cases, the image quality computation operation 204 could generate one or more additional metrics associated with the input image frame, such as signal-to-noise ratio (SNR) or other noise measurement of the input image frame.

A decision operation 206 generally operates to determine whether the visual quality of the input image frame is adequate. For example, the decision operation 206 may determine whether the brightness and/or contrast of the input image frame is adequately high, such as above one or more brightness and/or contrast thresholds. The decision operation 206 may also determine whether the SNR or other noise measurement of the input image frame is adequately low, such as below at least one noise threshold.

If the visual quality of the input image frame is not adequate, an adaptive affine model parameter identification operation 208 generally operates to identify parameters of an adaptive affine color correction model to be used to enhance the image frame. An affine model refers to a model that performs or defines an affine transformation of image data. An affine transformation can be generally expressed as a combination of a linear transformation and a translation. In some cases, for example, an adaptive affine color correction model can be defined as follows.

$${I}_{o u t} ( x , y ) = ρ {I}_{i n} ( x , y ) + δ$$

Here, Iᵢₙ(x, y) represents a pixel at coordinates (x, y) in an input image frame, Iₒᵤₜ(x, y) represents a pixel at coordinates (x, y) in a transformed or enhanced image frame, ρ represents a gain, and δ represents a bias. The value of the bias can be adjusted and used for brightness control, and the value of the gain can be adjusted and used for contrast control.

The adaptive affine color correction model used to enhance an image frame can be referred to as an adaptive model since the model parameters (like the gain and bias parameters) of the model can be selected or determined based on the contents of the image frame being enhanced. This supports dynamic estimation of model parameters for each image frame such that the affine color correction model can adaptively fit each image frame. In some embodiments, the parameters of the adaptive affine color correction model can also be selected using calibration data 210, such as camera color calibration data. Here, the camera color calibration data may include color parameters and initial values of the affine model parameters. In some cases, the camera color calibration data can be generated by a manufacturer during factory calibration of the electronic device 101. Also, in some cases, the camera color calibration data can vary based on the lighting in an environment being imaged using the electronic device 101. Thus, model parameters may be selected or updated according to environmental changes based on the stored camera color calibration data. In addition, the stored camera color calibration data may be updated over time, such as when model parameters are selected for use in certain lighting environments (such as those not included in the manufacturer data) and the model parameters are stored for subsequent use.

In some embodiments, the adaptive affine model parameter identification operation 208 could be implemented using one or more trained machine learning models, such as a neural network (like a convolutional neural network). In these embodiments, the neural network or other machine learning model(s) could be trained using training data to learn one or more relationships between the parameters of an adaptive affine color correction model (such as its gain and bias parameters) and the light environments of image frames. During use, input image frames can be provided to the trained neural network or other trained machine learning model(s), which can estimate the parameters of the adaptive affine color correction model based on those input image frames.

Once the affine model parameters are determined, an image visual quality enhancement operation 212 generally operates to process and enhance the input image frame using the adaptive affine color correction model that includes the determined parameters for that input image frame. For example, the image visual quality enhancement operation 212 may perform an image brightness enhancement function to adjust the brightness of parts or all of the image frame. The image visual quality enhancement operation 212 may also perform an image contrast enhancement function to adjust the contrast of parts or all of the image frame. In some embodiments, the brightness enhancement and/or the contrast enhancement can be performed using the affine transformation provided above, which allows for one or both of brightness enhancement and contrast enhancement depending on the bias and gain values. The image visual quality enhancement operation 212 may perform one or more additional enhancements, such as noise reduction, if needed or desired.

An image visual quality verification operation 214 may optionally be used here to support iterative enhancement of image frames. For example, the image visual quality verification operation 214 can analyze the resulting (enhanced) image frame generated by the image visual quality enhancement operation 212, and the decision operation 206 can determine if the visual quality of the resulting image frame is now acceptable. The image visual quality verification operation 214 may use any suitable technique(s) to verify whether image enhancement has been adequately applied. In some cases, for instance, the image visual quality verification operation 214 may use an image histogram and a cumulative distribution of the image data in the resulting (enhanced) image frame. If the visual quality of the resulting image frame is still not acceptable, another iteration of image enhancement could be performed. Note that the use of iterative enhancement is optional and need not be used. Also note that iterative enhancement may be performed any number of times, such as up to a specified maximum number of iterations.

A passthrough transformation operation 216 can be used to transform image frames, such as original input image frames (if enhancement is not applied) or enhanced image frames (if enhancement is applied). The passthrough transformation operation 216 generally operates to apply one or more transformations to image frames in order to transform image data from a viewpoint of an imaging sensor 180 to a viewpoint of a user's eye. Among other things, this could help to correct for parallax or other errors. In some cases, the passthrough transformation may include a static transformation and a dynamic transformation that collectively transform image data from the viewpoint of an imaging sensor 180 to the viewpoint of a user's eye. A static transformation may not depend on the contents of the image frames being processed and could be based on the components of the electronic device 101 and/or the configuration of the components of the electronic device 101, which may generally remain constant during use (although some modifications, such as changes to accommodate different interpupillary distances (IPDs) between the eyes of different users, may be permitted). A dynamic transformation can vary based on the contents of the image frames being processed.

In some embodiments, the static transformation can include a camera undistortion transformation, an HMD geometric transformation, and/or a display geometric distortion calibration (GDC)/chromatic aberration correction (CAC) transformation. A camera undistortion transformation can be used to correct for lens distortions in captured image frames caused by one or more lenses of one or more imaging sensors 180 used to capture the image frames. An HMD geometric transformation can be used to correct for distortions caused by the layout and arrangement of the imaging sensors 180 relative to the user's eyes, such as when the imaging sensors 180 are not positioned directly in front of the user's eyes. A display GDC/CAC transformation can be used to pre-compensate image frames for expected geometric distortions and chromatic aberrations created when rendered images are displayed and viewed through display lenses of the electronic device 101. Each of these transformations (or a combination of two or more of these transformations) may be implemented in any suitable manner, such as by warping or otherwise modifying image frames to achieve the desired correction(s).

In some embodiments, the dynamic transformation can include a time warp reprojection, a planar reprojection, or a depth-based reprojection. A time warp reprojection generally refers to a reprojection of image data from one image frame to another, where the image data is generally within a common plane in both image frames. A planar reprojection generally refers to a reprojection of image data onto a single plane, such as when all background image content is reprojected to a single plane at a single specified depth from the electronic device 101. A depth-based reprojection generally refers to a reprojection of image data based on depths associated with the image data. In general, time warp reprojection is typically less computationally expensive than planar reprojection, and planar reprojection is typically less computationally expensive than depth-based reprojection. The specific type of reprojection being used could be based on, among other things, whether the user's head pose has changed significantly in between image frame captures and/or where the user's eyes are focused within a scene.

A final view rendering and display operation 218 generally operates to generate and render final images for display and to initiate display of the rendered images. For example, the final view rendering and display operation 218 may process transformed/enhanced image frames and perform any additional refinements or modifications needed or desired, where the resulting images can represent the final views of the scene. As a particular example, a 3D-to-2D warping function could be used to warp the final views of the scene into 2D images. The final view rendering and display operation 218 can present the 2D images to a user, such as by rendering the 2D images into a form suitable for transmission to at least one display 160. Note that the at least one display 160 could include a single display in which different rendered images are presented on different portions of one display panel or multiple displays in which different rendered images are presented on different display panels.

The process 200 shown in FIG. 2 can have various technical benefits or advantages depending on the implementation. For example, the process 200 can be used to efficiently create an adaptive affine color correction model via appropriate model parameter estimation, which could be done on a per-image frame basis in some cases. Image visual quality enhancements, such as in terms of brightness and contrast, can be obtained using the adaptive affine color correction model, which can improve the overall appearance of the resulting rendered images. In addition, verification of the image visual quality, such as in terms of brightness and contrast, for the enhanced image frames can be performed to determine whether additional enhancement may be needed.

Although FIG. 2 illustrates one example of a process 200 for image enhancement of low-light or other images with an adaptive affine color correction model, various changes may be made to FIG. 2. For example, various operations or functions in FIG. 2 may be combined, further subdivided, replicated, omitted, or rearranged and additional operations or functions may be added according to particular needs. As a particular example, the passthrough transformation operation 216 may occur before the image visual quality enhancement operation 212 (and possibly before the image quality computation operation 204). Among other things, this may allow the image visual quality enhancement operation 212 to correct for color changes or other issues created by the passthrough transformation operation 216.

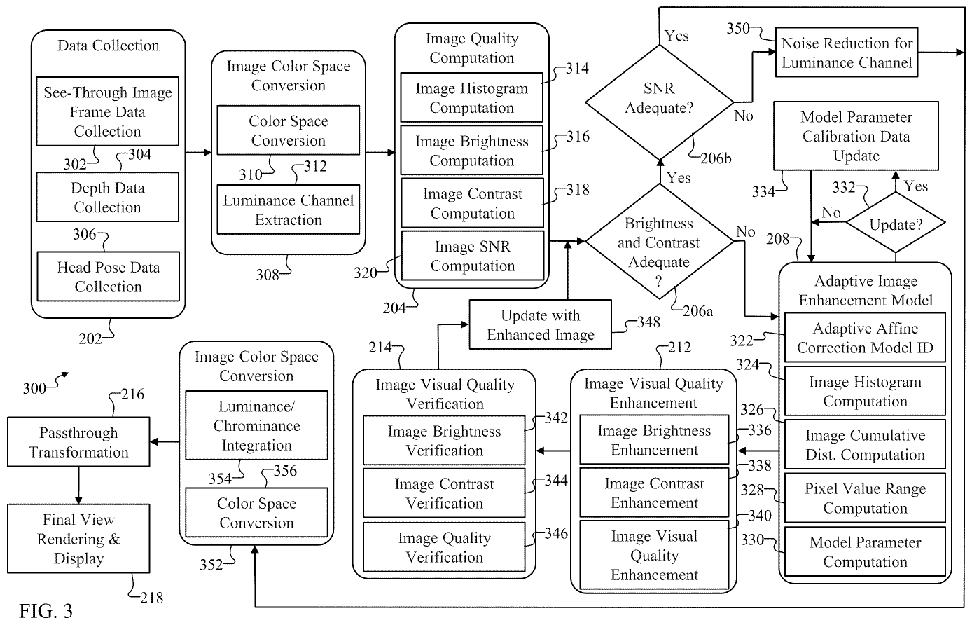

FIG. 3 illustrates a more specific example process 300 for image enhancement of low-light or other images with an adaptive affine color correction model in accordance with this disclosure. The process 300 here can represent a more specific implementation of the process 200 shown in FIG. 2. For ease of explanation, the process 300 shown in FIG. 3 is described as being implemented using the electronic device 101 in the network configuration 100 shown in FIG. 1. However, the process 300 shown in FIG. 3 may be implemented using any other suitable device(s) and in any other suitable system(s).

As shown in FIG. 3, the data collection operation 202 may be implemented using a see-through image frame data collection function 302, a depth data collection function 304, and a head pose data collection function 306. The image frame data collection function 302 generally operates to obtain see-through color image frames or other image frames of scenes, such as by obtaining image frames captured using one or more see-through or other imaging sensors 180 of the electronic device 101. In some cases, each captured image frame may represent an image frame of a scene captured by a forward-facing or other imaging sensor(s) 180 of the electronic device 101.

The depth data collection function 304 generally operates to obtain depth data associated with each image frame. The depth data may be obtained from any suitable source(s), such as from one or more depth sensors like at least one ToF, LiDAR, or stereo vision sensor. In some cases, for example, the depth data may include time measurements of light pulses returning to a ToF sensor, distorted light patterns, or RGB images from slightly different angles. The head pose data collection function 306 generally operates to obtain information related to the pose of the user's head while the electronic device 101 is being used. The head pose information may be obtained from any suitable source(s), such as from one or more positional sensors like at least one IMU. In some cases, the head pose information may be expressed using six degrees of freedom, such as three translation values and three rotation values. Note, however, that the head pose information may have any other suitable form.

An image color space conversion operation 308 may optionally be used to adjust the color space of the input image frames being processed. The image color space conversion operation 308 may be implemented using a color space conversion function 310 and a luminance channel extraction function 312. The color space conversion function 310 generally operates to convert image data from a first color space to a second color space, namely one that includes a luminance channel. The first color space may or may not already include a luminance channel. For example, the color space conversion function 310 could convert image data from the RGB color space to the YUV or YCbCr color space, the hue, saturation, and value (HSV) color space, or other suitable color space. The luminance channel extraction function 312 generally operates to separate the luminance channel from other color channels (such as chrominance channels) of the input image frames as converted by the color space conversion function 310. This approach allows image data in the luminance channel of each input image frame to be processed and enhanced, such as to improve the brightness and/or contrast of each input image frame.

The image quality computation operation 204 may be implemented using an image histogram computation function 314, an image brightness computation function 316, an image contrast computation function 318, and an image SNR (or other noise) computation function 320. The image histogram computation function 314 generally operates to calculate a histogram for each input image frame or for the luminance channel of each input image frame. Among other things, the histogram of an image frame can be used to check the color balance of the image frame. The image brightness computation function 316 can be used to calculate the overall brightness of each image frame, and the image contrast computation function 318 can be used to calculate the overall contrast of each image frame. These two metrics can be used as a measure of one or more light conditions of each image frame. The image SNR computation function 320 can be used to calculate the overall noise of each image frame, which can be used to check the overall noise level of each image frame.

The decision operation 206 may be implemented using a first decision operation 206a and a second decision operation 206b. The first decision operation 206a generally operates to determine whether the overall brightness of an image frame and the overall contrast of the image frame are adequate, such as by determining if the overall brightness meets or exceeds a brightness threshold and if the overall contrast meets or exceeds a contrast threshold. The second decision operation 206b generally operates to determine whether the overall noise of the image frame is adequate, such as by determining if the overall noise is less than or equal to a noise threshold.

If the overall brightness and/or the overall contrast of the image frame is not adequate, the adaptive affine model parameter identification operation 208 can be performed. The adaptive affine model parameter identification operation 208 may be implemented using an adaptive affine correction model identification (ID) function 322, an image histogram computation function 324, an image cumulative distribution computation function 326, a pixel value range computation function 328, and a model parameter computation function 330. The adaptive affine correction model identification function 322 generally operates to define an adaptive affine color correction model with parameters for brightness and contrast control. In some cases, the adaptive affine correction model identification function 322 could simply use a model based on the affine transformation defined above. In other cases, the adaptive affine correction model identification function 322 could use other (possibly more complex) affine transformations. In some embodiments, for instance, different affine transformations could be used depending on the level of illumination present in the image frame being processed.

The image histogram computation function 324 generally operates to calculate a histogram for each input image frame or for the luminance channel of each input image frame. During a first iteration of enhancement, the image histogram computation function 324 may use the same histogram produced by the image histogram computation function 314. In subsequent iterations of enhancement, the image histogram computation function 324 may generate a histogram for the enhanced image frame produced during the preceding iteration of enhancement. The image cumulative distribution computation function 326 generally operates to calculate a cumulative distribution of the image frame being processed based on its histogram. The cumulative distribution of image data refers to the cumulative sum of probabilities or relative frequencies up to each bin of the associated histogram, which can be used to essentially define the probability distribution of the image data. The cumulative distribution enables the identification of color frequencies less than a specified threshold. The pixel value range computation function 328 generally operates to identify a range of pixel values based on the cumulative distribution, such as by cutting off the left and right sides of the histogram and identifying a range of values remaining in the cumulative distribution. The model parameter computation function 330 generally operates to select parameters for an adaptive affine color correction model (such as bias and gain parameters) using the pixel value range.

In some embodiments, model parameters may be provided to an update decision function 332, which generally operates to determine if the model parameters should be stored (such as for later use). If so, a model parameter calibration data update function 334 can be used to store the model parameters as calibration data, such as when stored as part of the calibration data 210. If not, no parameter update may be needed.

The model parameters are provided to the image visual quality enhancement operation 212. The image visual quality enhancement operation 212 may be implemented using an image brightness enhancement function 336, an image contrast enhancement function 338, and an image visual quality enhancement function 340. The image brightness enhancement function 336 generally operates to enhance image brightness with the estimated bias parameter, and the image contrast enhancement function 338 generally operates to enhance image contrast with the estimated gain parameter. The image visual quality enhancement function 340 can integrate the brightness and contrast enhancements, possibly with one or more additional types of enhancements (such as histogram-based equalization). Note that while these are shown as separate functions here, at least the brightness and contrast enhancements could be implemented together through a single application of the adaptive affine color correction model with the selected bias and gain parameters.

The image visual quality verification operation 214 may be implemented using an image brightness verification function 342, an image contrast verification function 344, and an image quality verification function 346. The image brightness verification function 342 generally operates to process the enhanced image frame from the image visual quality enhancement operation 212 and determine if the image brightness of the enhanced image frame is now adequate. The image contrast verification function 344 generally operates to process the enhanced image frame from the image visual quality enhancement operation 212 and determine if the image contrast of the enhanced image frame is now adequate. The image quality verification function 346 generally operates to process the enhanced image frame from the image visual quality enhancement operation 212 and determine if the overall image quality of the enhanced image frame is now adequate. In some cases, the verifications can involve determining the mean, standard deviation, and SNR of the image data in the enhanced image frame to verify the quality of the enhanced image frame. An update function 348 can be used to update the pipeline with the enhanced image frame and the previously-estimated parameters of the affine color correction model, allowing the process 300 to perform the decision operations 206a-206b again.

If the overall brightness and the overall contrast of the image frame are adequate but the noise is not, a noise reduction function 350 can be performed to reduce the noise in at least the luminance channel of the input image frame being processed. Various techniques can be used to perform denoising, such as various types of filtering using various kernel sizes of filters. Note, however, that this disclosure is not limited to any specific technique(s) for image noise reduction.

Once the overall brightness, overall contrast, and noise of an image frame (either an original input image frame or an enhanced image frame) are adequate, an image color space conversion operation 352 may optionally be used to adjust the color space of the image frame. The image color space conversion operation 352 may be implemented using a luminance/chrominance integration function 354 and a color space conversion function 356. The luminance/chrominance integration function 354 generally operates to combine the luminance and chrominance channels (or other color channels) of an original input image frame or an enhanced image frame. The color space conversion function 356 generally operates to convert image data from the second color space to the first color space or a third color space, which may or may not include a luminance channel. For example, the color space conversion function 356 could convert image data from the YUV or YCbCr color space or the HSV color space to the RGB color space or other suitable color space. After color space conversion, the passthrough transformation operation 216 and the final view rendering and display operation 218 may be performed.

Although FIG. 3 illustrates a more specific example of a process 300 for image enhancement of low-light or other images with an adaptive affine color correction model, various changes may be made to FIG. 3. For example, various operations or functions in FIG. 3 may be combined, further subdivided, replicated, omitted, or rearranged and additional operations or functions may be added according to particular needs. As a particular example, the passthrough transformation operation 216 may occur before the image visual quality enhancement operation 212 (and possibly before the image quality computation operation 204).

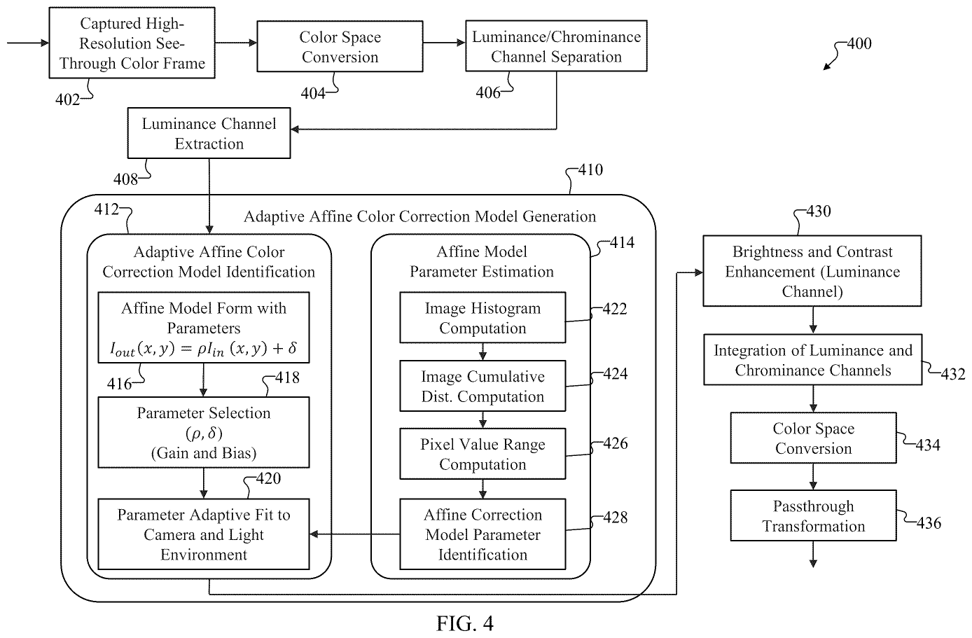

FIG. 4 illustrates an example process 400 for adaptive affine color correction model generation in accordance with this disclosure. The process 400 may, for example, be used to implement at least part of the functionality of the adaptive affine model parameter identification operation 208 described above. For ease of explanation, the process 400 shown in FIG. 4 is described as being implemented using the electronic device 101 in the network configuration 100 shown in FIG. 1. However, the process 400 shown in FIG. 4 may be implemented using any other suitable device(s) and in any other suitable system(s).

As shown in FIG. 4, the process 400 can receive captured high-resolution see-through color image frames or other image frames 402, such as image frames obtained using the data collection operation 202 (like the see-through image frame data collection function 302). The image frames 402 can be processed using a color space conversion operation 404, which could represent the color space conversion function 310 discussed above. A luminance/chrominance channel separation function 406 and a luminance channel extraction function 408, which could represent the luminance channel extraction function 312 discussed above, can be used to isolate luminance channel data of each image frame 402.

An adaptive affine color correction model generation operation 410 could represent one example implementation of the adaptive affine model parameter identification operation 208. In this example, the adaptive affine color correction model generation operation 410 includes an adaptive affine color correction model identification function 412 and an affine model parameter estimation function 414. The adaptive affine color correction model identification function 412 may be implemented using an affine color correction model definition function 416, a parameter selection function 418, and an adaptive fit function 420. The affine model parameter estimation function 414 may be implemented using an image histogram computation function 422, an image cumulative distribution computation function 424, a pixel value range computation function 426, and a model parameter identification function 428. These functions 416-428 could represent the various functions 322-330 discussed above.

The adaptive affine color correction model identification function 412 generally operates to identify a form of an adaptive affine color correction model to be used. As described above, an adaptive affine color correction model could be defined as follows.

$${I}_{o u t} ( x , y ) = ρ {I}_{i n} ( x , y ) + δ$$

The parameter selection function 418 can generate initial estimates of the parameters of the adaptive affine color correction model, such as its bias and gain parameters, to be used during image enhancement. In some cases, the parameters can be estimated based on one or more light conditions (such as brightness and contrast) of the image frame being processed, as well as any requirements of the image frame (such as a desired brightness value or range of acceptable brightness values and/or a desired contrast value or range of acceptable contrast values). Different lighting conditions while capturing image frames can be associated with different gains and biases, and the adaptive fit function 420 can adaptively fit individual image frames to parameter values according to the associated lighting environment and one or more camera properties. In this way, the gain p can be applied for controlling contrast, and the bias parameter δ can be applied for controlling brightness.

The image histogram computation function 422 can determine a histogram of the image data for the luminance channel of each input image frame, and the image cumulative distribution computation function 424 can determine a cumulative distribution based on the histogram. In some cases, the gain and bias can be selected so that the pixel values of the enhanced image frame being generated are in the range [0, 255]. During optimization, the cumulative distribution can be computed to determine where color frequency is less than a specified threshold. The pixel value range computation function 426 can determine a range of pixel values based on the cumulative distribution, such as by cutting off the left and right sides of the histogram. This creates an identified range within the cumulative distribution with minimum and maximum pixel values. Using that range, the model parameter identification function 428 can determine the gain and bias parameters to be used for image enhancement of the input image frame.

As a particular example of this, affine model parameters ρ and δ can be determined adaptively for a current image frame being processed as follows. A histogram Hₕᵢₛₜ of luminance channel data of the current image frame may be defined as follows.

$${H}_{h i s t} = h ( {I}_{1} ( x , y ) , {N}_{b i n} )$$

Here, Iₗ(x, y) represents a pixel at coordinates (x, y) in the luminance channel of the current image frame, and N_{bin} represents the number of bins of the histogram. A cumulative distribution H_{cum} of the luminance channel of the current image frame can be determined using the histogram, such as in the following manner.

$${H}_{c u m} = {h}_{c u m} ( {H}_{h i s t} ( i ) )$$

Here, h_{cum} represents the distribution for specific histogram bins, where i=0, 1, . . . , Nₕᵢₛₜ and Nₕᵢₛₜ represents the size of the histogram. The pixel value range can be determined with a threshold applied to the cumulative distribution, and the range may be defined in the following manner.

$$[ {p}_{lower} , {p}_{u p p e r} ]$$

Here, p_{lower} and pᵤₚₚₑᵣ represent the lower and upper values of the range. Given that, the gain ρ and bias δ could be calculated as follows.

$$ρ = \frac{255}{{p}_{u pper} - {p}_{l o w e r}}$$

$$δ = - {p}_{l o wer} ρ$$

Once the model parameters are identified, a brightness and contrast enhancement function 430 can be performed, which could represent the image visual quality enhancement operation 212 described above. An integration function 432, which could represent the luminance/chrominance integration function 354 described above, can integrate the (modified) luminance and chrominance channels of the enhanced image frame. A color space conversion function 434, which could represent the color space conversion function 356 discussed above, can convert the color space of the enhanced image frame. A passthrough transformation function 436 could represent the passthrough transformation operation 216 described above.

Although FIG. 4 illustrates one example of a process 400 for adaptive affine color correction model generation, various changes may be made to FIG. 4. For example, various operations or functions in FIG. 4 may be combined, further subdivided, replicated, omitted, or rearranged and additional operations or functions may be added according to particular needs. As a particular example, the passthrough transformation function 436 may occur earlier in the process 400.

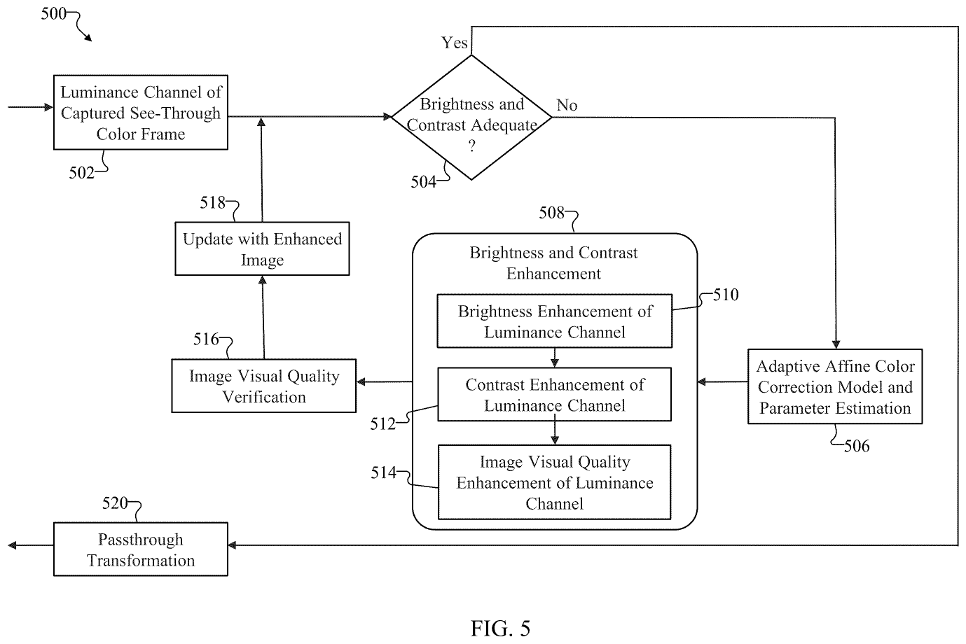

FIG. 5 illustrates an example process 500 for image brightness and contrast enhancement of low-light or other images with an adaptive affine color correction model in accordance with this disclosure. The process 500 may, for example, be used to implement at least part of the functionality of the image visual quality enhancement operation 212 described above. For ease of explanation, the process 500 shown in FIG. 5 is described as being implemented using the electronic device 101 in the network configuration 100 shown in FIG. 1. However, the process 500 shown in FIG. 5 may be implemented using any other suitable device(s) and in any other suitable system(s).

As shown in FIG. 5, the process 500 can receive luminance channels 502 of captured high-resolution see-through color image frames or other image frames, such as image frames 402 obtained using the data collection operation 202 (like the see-through image frame data collection function 302). A decision function 504, which could represent the decision operation 206 or 206a described above, can determine whether the brightness and contrast of the luminance channel 502 of each image frame being processed is acceptable. If not, an adaptive affine color correction model and parameter estimation function 506 can be used, which could represent the adaptive affine model parameter identification operation 208 or the adaptive affine color correction model generation operation 410 described above.

A brightness and contrast enhancement function 508 can be used to enhance the brightness, contrast, and overall visual quality of an image frame and could represent the image visual quality enhancement operation 212 described above. For example, a brightness enhancement function 510 can adjust the brightness of the luminance data for the luminance channel 502 of an image frame being processed. A contrast enhancement function 512 can adjust the contrast of the luminance data for the luminance channel 502 of an image frame being processed. An image visual quality enhancement function 514 can integrate the adjustments of the brightness and contrast of the luminance data for the luminance channel 502 of an image frame being processed, possibly along with one or more additional types of image enhancement. These functions 510-514 could represent the functions 336-340 described above.

In some cases, the brightness and contrast enhancements provided here could be defined as follows.

$${L}_{o u t} ( x , y ) = \hat{ρ} {L}_{i n} ( x , y ) + \hat{δ}$$

Here, L(x, y) represents a pixel at coordinates (x, y) in the luminance channel of an input image frame, Lₒᵤₜ(x, y) represents a pixel at coordinates (x, y) in the luminance channel of a transformed or enhanced image frame, and (\hat{ρ}, \hat{δ}) represent estimated parameters of the adaptive affine color correction model.

An image visual quality verification function 516, which could represent the image visual quality verification operation 214, can verify if adequate image enhancement has been achieved. In some cases, image visual quality verification may occur as follows. The image visual quality verification function 516 can compute the mean and standard deviation (μ, σ) and the SNR of the enhanced image frame generated by the brightness and contrast enhancement function 508. The mean u and standard deviation σ could be determined as follows.

$$\{ \begin{matrix}μ = \frac{1}{M N} {\sum }_{i = 0}^{N - 1} {\sum }_{j = 0}^{M - 1} {I}_{o u t} ( x , y ) \\ σ = \frac{1}{M N} {\sum }_{i = 0}^{N - 1} {\sum }_{j = 0}^{M - 1} {( {I}_{o u t} ( x , y ) - μ )}^{2}\end{matrix}$$

Here, (M, N) represents an image frame size (where M is the image frame width and N is the image frame height), and Iₒᵤₜ(x, y) (which could be replaced by Lₒᵤₜ(x, y)) represents the pixel at coordinates (x, y) in the luminance channel of the enhanced image frame. The image frame's overall brightness can be defined using the mean value of the image frame as follows.

$$B ( {I}_{o u t} ) = μ$$

A threshold T_{B} or a threshold range [T_{B}_{_{lower}}, T_{B}_{ᵤₚₚₑᵣ}] can be defined, and a determination can be made whether the calculated brightness matches the threshold or is within the threshold range (if so, the brightness of the enhanced image frame can be acceptable). The image frame's overall contrast can be defined using the standard deviation value of the image frame as follows.

$$C ( {I}_{o u t} ) = σ$$

A threshold T_{C} or a threshold range [T_{C}_{_{lower}}, T_{C}_{ᵤₚₚₑᵣ}] can be defined, and a determination can be made whether the calculated contrast matches the threshold or is within the threshold range (if so, the contrast of the enhanced image frame can be acceptable).

In addition, the image visual quality verification function 516 could consider the noise present in the enhanced image frame. For example, a signal value P_{signal} could be defined using the mean μ of the enhanced image frame, and a noise value Pₙₒᵢₛₑ could be defined using the standard deviation σ of the enhanced image frame. The SNR of the enhanced image frame could be expressed as follows.

$$SNR = 10 {log}_{10}^{( \frac{{P}_{s i gnal}}{{P}_{n o i s e}} )}$$

A threshold T_{SNR} can be defined, and the computed SNR can be compared with the threshold to determine if the SNR of the enhanced image frame is acceptable.

If another iteration of enhancement is needed or desired, an update function 518 can be used, which could represent the model parameter calibration data update function 334 described above. If no iteration of enhancement or no additional iteration of enhancement is needed, a passthrough transformation function 520 can be performed, which could represent the passthrough transformation operation 216 or the passthrough transformation function 436 described above.

Although FIG. 5 illustrates one example of a process 500 for image brightness and contrast enhancement of low-light or other images with an adaptive affine color correction model, various changes may be made to FIG. 5. For example, various operations or functions in FIG. 4 may be combined, further subdivided, replicated, omitted, or rearranged and additional operations or functions may be added according to particular needs. As a particular example, the passthrough transformation function 520 may occur earlier in the process 500.

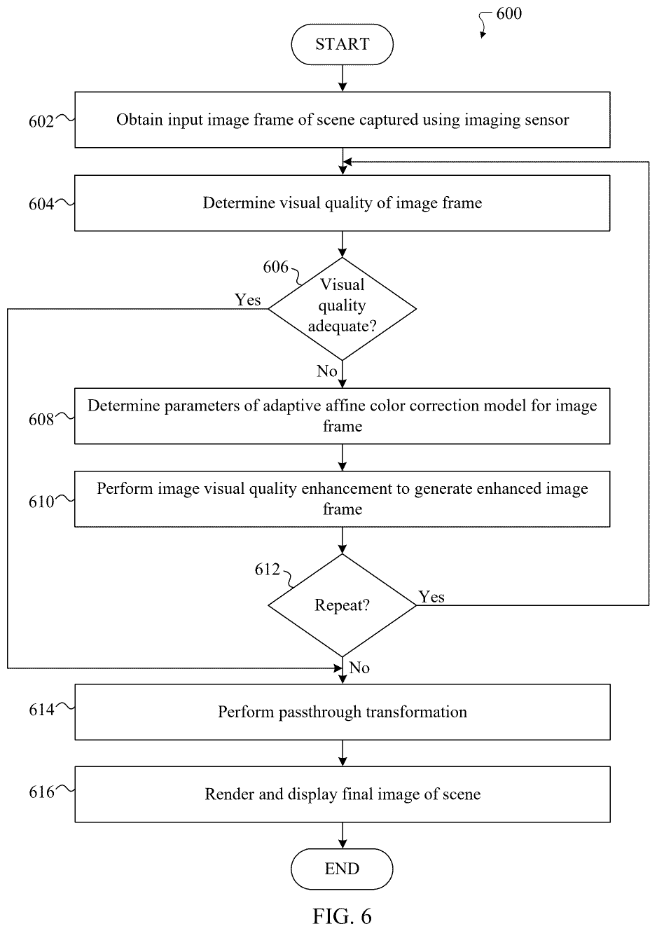

FIG. 6 illustrates an example method 600 for image enhancement of low-light or other images with an adaptive affine color correction model in accordance with this disclosure. For ease of explanation, the method 600 shown in FIG. 6 is described as being implemented using the electronic device 101 in the network configuration 100 shown in FIG. 1. However, the method 600 shown in FIG. 6 may be implemented using any other suitable device(s) and in any other suitable system(s).

As shown in FIG. 6, an input image frame captured using an imaging sensor is obtained at step 602. This may include, for example, the processor 120 of the electronic device 101 performing the data collection operation 202 to obtain an input image frame 402. Any desired pre-processing of the input image frame 402 may occur here, such as when the image color space conversion operation 308 is used. A visual quality of the input image frame may be determined at step 604, and a determination may be made whether the visual quality of the input image frame is acceptable at step 606. This may include, for example, the processor 120 of the electronic device 101 performing the image quality computation operation 204 to determine one or more light conditions (such as brightness and/or contrast) of the input image frame 402 and SNR or other noise level of the input image frame 402. This may also include the processor 120 of the electronic device 101 performing the decision operation(s) 206, 206a-206b to determine whether the input image frame 402 should undergo image enhancement.

If the visual quality is not acceptable, parameters of an adaptive affine color correction model are determined based on the input image frame at step 608. This may include, for example, the processor 120 of the electronic device 101 performing the adaptive affine model parameter identification operation 208 or the adaptive affine color correction model generation operation 410 to generate bias and gain parameters for the adaptive affine color correction model. The bias and gain parameters can be based on the contents of the input image frame. As a particular example, the parameters can be determined by generating a histogram using the image frame, determining a cumulative distribution of the image frame using the histogram, determining a pixel value range for enhancement using the cumulative distribution, and determining the parameters of the adaptive affine color correction model using the pixel value range. In some cases, the parameters of the adaptive affine color correction model may be based on calibration data 210, such as from calibration of the imaging sensor 180.

Image visual quality enhancement is performed using the adaptive affine color correction model to generate an enhanced image frame based on the input image frame at step 610. This may include, for example, the processor 120 of the electronic device 101 performing the image visual quality enhancement operation 212 or the brightness and contrast enhancement function 508 to adjust the brightness and/or contrast of the image frame and generate the enhanced image frame. This may also include the processor 120 of the electronic device 101 performing the noise reduction function 350 to reduce the noise contained in the enhanced image frame.

A determination can be made whether to repeat enhancement at step 612. This may include, for example, the processor 120 of the electronic device 101 determining whether the enhanced image frame has acceptable brightness, contrast, and noise. If the visual quality of the enhanced image frame is still not acceptable, the method 600 can return to step 604 (or other earlier step) to perform another iteration of image enhancement. Otherwise, a passthrough transformation may be performed at step 614. This may include, for example, the processor 120 of the electronic device 101 performing the passthrough transformation operation 216, passthrough transformation function 436, or passthrough transformation function 520. The passthrough transformation could include a static transformation and a dynamic transformation that collectively transform image data from a viewpoint of the imaging sensor 180 that captured the input image frame to a viewpoint of a user's eye. Any desired post-processing of the enhanced image frame may also occur, such as when the image color space conversion operation 352 is used. Display of a rendered image based on the enhanced image frame is initiated at step 616. This may include, for example, the processor 120 of the electronic device 101 performing the final view rendering and display operation 218 to generate a final view of a scene based on the original or enhanced image frame and rendering the final view as an image that can be displayed on at least one display panel of the electronic device 101.

Although FIG. 6 illustrates one example of a method 600 for image enhancement of low-light or other images with an adaptive affine color correction model, various changes may be made to FIG. 6. For example, while shown as a series of steps, various steps in FIG. 6 could overlap, occur in parallel, occur in a different order, or occur any number of times (including zero times). As a particular example, the determination and consideration of the image visual quality may be optional. As another particular example, the passthrough transformation may occur earlier in the method 600 (if at all).

It should be noted that the functions shown in or described with respect to the figures can be implemented in an electronic device 101, 102, 104, server 106, or other device(s) in any suitable manner. For example, in some embodiments, at least some of the functions shown in or described with respect to the figures can be implemented or supported using one or more software applications or other software instructions that are executed by the processor 120 of the electronic device 101, 102, 104, server 106, or other device(s). In other embodiments, at least some of the functions shown in or described with respect to the figures can be implemented or supported using dedicated hardware components. In general, the functions shown in or described with respect to the figures can be performed using any suitable hardware or any suitable combination of hardware and software/firmware instructions. Also, the functions shown in or described with respect to the figures can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, an input image frame captured using an imaging sensor;
determining, using the at least one processing device, parameters of an adaptive affine color correction model based on the input image frame;
performing, using the at least one processing device, image visual quality enhancement using the adaptive affine color correction model to generate an enhanced image frame based on the input image frame; and
initiating, using the at least one processing device, display of a rendered image based on the enhanced image frame.

2. The method of claim 1, further comprising:
identifying one or more light conditions of the input image frame; and
determining whether the one or more light conditions of the input image frame are acceptable;
wherein the image visual quality enhancement is performed in response to determining that the one or more light conditions of the input image frame are not acceptable.

3. The method of claim 2, wherein:
the one or more light conditions comprise a brightness and a contrast of the input image frame; and
the parameters of the adaptive affine color correction model comprise a bias for brightness control and a gain for contrast control.

4. The method of claim 1, further comprising:
after performing the image visual quality enhancement, performing image visual quality verification of a resulting image frame; and
repeating determination of the parameters of the adaptive affine color correction model and performance of the image visual quality enhancement using the resulting image frame in response to the image visual quality verification.

5. The method of claim 1, wherein determining the parameters of the adaptive affine color correction model comprises:
generating a histogram using the input image frame;
determining a cumulative distribution of the input image frame using the histogram;
determining a pixel value range for enhancement using the cumulative distribution; and
determining the parameters of the adaptive affine color correction model using the pixel value range.

6. The method of claim 1, further comprising:
prior to determining the parameters of the adaptive affine color correction model, converting the input image frame from a first color space into a second color space having a luminance channel; and
after performing the image visual quality enhancement, converting the enhanced image frame from the second color space to the first color space or to a third color space;
wherein the parameters of the adaptive affine color correction model are determined based on the luminance channel.

7. The method of claim 1, wherein:
the parameters of the adaptive affine color correction model are based on calibration data from calibration of the imaging sensor; and
the method further comprises updating the calibration data over time.

8. The method of claim 1, further comprising:
performing noise reduction to generate the enhanced image frame.

9. The method of claim 1, further comprising:
applying a passthrough transformation to the input image frame or the enhanced image frame, the passthrough transformation comprising a static transformation and a dynamic transformation that collectively transform image data from a viewpoint of the imaging sensor to a viewpoint of a user's eye.

10. An apparatus comprising:
at least one processing device configured to:
obtain an input image frame captured using an imaging sensor;
determine parameters of an adaptive affine color correction model based on the input image frame;
perform image visual quality enhancement using the adaptive affine color correction model to generate an enhanced image frame based on the input image frame; and
initiate display of a rendered image based on the enhanced image frame.

11. The apparatus of claim 10, wherein:
the at least one processing device is further configured to:
identify one or more light conditions of the input image frame; and
determine whether the one or more light conditions of the input image frame are acceptable;
wherein the at least one processing device is configured to perform the image visual quality enhancement in response to determining that the one or more light conditions of the input image frame are not acceptable.

12. The apparatus of claim 11, wherein:
the one or more light conditions comprise a brightness and a contrast of the input image frame; and
the parameters of the adaptive affine color correction model comprise a bias for brightness control and a gain for contrast control.

13. The apparatus of claim 10, wherein the at least one processing device is further configured to:
after performing the image visual quality enhancement, perform image visual quality verification of a resulting image frame; and
repeat determination of the parameters of the adaptive affine color correction model and performance of the image visual quality enhancement using the resulting image frame in response to the image visual quality verification.

14. The apparatus of claim 10, wherein, to determine the parameters of the adaptive affine color correction model, the at least one processing device is configured to:
generate a histogram using the input image frame;
determine a cumulative distribution of the input image frame using the histogram;
determine a pixel value range for enhancement using the cumulative distribution; and
determine the parameters of the adaptive affine color correction model using the pixel value range.

15. The apparatus of claim 10, wherein the at least one processing device is further configured to perform noise reduction to generate the enhanced image frame.

16. A non-transitory machine readable medium containing instructions that when executed cause at least one processor of an electronic device to:
obtain an input image frame captured using an imaging sensor;
determine parameters of an adaptive affine color correction model based on the input image frame;
perform image visual quality enhancement using the adaptive affine color correction model to generate an enhanced image frame based on the input image frame; and
initiate display of a rendered image based on the enhanced image frame.

17. The non-transitory machine readable medium of claim 16, further containing instructions that when executed cause the at least one processor to:
identify one or more light conditions of the input image frame; and
determine whether the one or more light conditions of the input image frame are acceptable;
wherein the instructions when executed cause the at least one processor to perform the image visual quality enhancement in response to determining that the one or more light conditions of the input image frame are not acceptable.

18. The non-transitory machine readable medium of claim 17, wherein:
the one or more light conditions comprise a brightness and a contrast of the input image frame; and
the parameters of the adaptive affine color correction model comprise a bias for brightness control and a gain for contrast control.

19. The non-transitory machine readable medium of claim 16, further containing instructions that when executed cause the at least one processor to:
after performing the image visual quality enhancement, perform image visual quality verification of a resulting image frame; and
repeat determination of the parameters of the adaptive affine color correction model and performance of the image visual quality enhancement using the resulting image frame in response to the image visual quality verification.

20. The non-transitory machine readable medium of claim 16, wherein the instructions that when executed cause the at least one processor to determine the parameters of the adaptive affine color correction model comprise instructions that when executed cause the at least one processor to:
generate a histogram using the input image frame;
determine a cumulative distribution of the input image frame using the histogram;
determine a pixel value range for enhancement using the cumulative distribution; and
determine the parameters of the adaptive affine color correction model using the pixel value range.
